(19) United States
(12) Patent Application Publication
(10) Pub. No.: US 2021/0267193 A1
(43) Pub. Date: Sep. 2, 2021

(54) Pest Repellent Agent

(71) Applicant: Kao Corporation, Chuo-ku, Tokyo (JP)

(72) Inventors: Hiroaki IIKURA, Fujisawa-shi, Kanagawa (JP); Satoshi OZAWA, Adachi-ku, Tokyo (JP)

(73) Assignee: Kao Corporation, Chuo-ku, Tokyo (JP)

(21) Appl. No.: 17/277,469

(22) PCT Filed: Sep. 25, 2019
(86) PCT No.: PCT/JP2019/037452

§ 371 Date: Mar. 18, 2021

(30) Foreign Application Priority Data
Sep. 28, 2018 (JP) 2018-185457
Dec. 17, 2018 (JP) 2018-235546

(51) Int. Cl. A01N 25/02; A01N 37/02; A01N 31/02; A01N 37/10; A01N 27/00

(52) U.S. Cl. CPC A01N 25/02; A01N 37/02; A01N 27/00; A01N 37/10; A01N 31/02

(57) ABSTRACT

The present invention relates to [1] a pest repellent including, as an active ingredient, at least one liquid oily component selected from the group consisting of a silicone oil, an ester oil, an ether oil, a hydrocarbon oil, an aliphatic higher alcohol having 14 or more carbon atoms, and a polyhydric alcohol, the liquid oily component having a surface tension at 25° C. of 40 mN/m or less and a viscosity at 23° C. as measured with a B-type rotational viscometer of 1,200 mPa·s or less; [2] a pest repellent composition containing the aforementioned liquid oily component and not containing an effective amount of other pest repellent; and [3] a method for repelling pests, including applying the aforementioned pest repellent or pest repellent composition onto the skin surface of a human such that the amount of the liquid oily component is 0.1 mg or more per 1 cm².

The pest repellent of the present invention is excellent in repellent effect against pests, particularly flying pests, and is safe and has a low odor.

### FIELD OF THE INVENTION

The present invention relates to a pest repellent, a pest repellent composition, and a method for repelling pests.

### BACKGROUND OF THE INVENTION

Pests, for example, flying pests, such as mosquitoes and flies, are factors that cause pathogens in animals, such as humans, to cause infectious diseases and dermatitis. In particular, some mosquitoes are hygienically very harmful insects because they carry pathogens, such as dengue fever, Zika fever, yellow fever, encephalitis, and malaria.

Conventionally, in order to protect themselves from such flying pests, a method of spraying an insecticide or applying a repellent onto the skin surface has been widely used. As a typical repellent, DEET (N,N-diethyl-m-toluamide) is commonly used.

Pests, such as mosquitoes, possess chemoreceptive systems, such as thermal receptors that sense the body temperature of animals, olfactory receptors that sense volatile substances, such as body odors, and carbon dioxide receptors that sense carbon dioxide, and detect the animals. However, DEET repels pests by modulating the chemoreceptive system of such pests and neutralizing the cognitive sensation of the pest.

However, DEET involves such problems that it has an unpleasant odor, and also requires a large amount of the compound to exhibit a sufficient repellent effect, which limits the number of uses for infants and people with sensitive skin.

Then, utilization of natural essential oils as a repellent component is studied, and natural essential oils, such as citronella oil, lemon eucalyptus oil, lemongrass oil, orange oil, and cassia oil, are also used for candles and aroma lotions. However, their repellent effect against pests is not sufficient, and their practicality is problematic.

Besides, various proposals have been made for pest repellents.

For example, JP 8-81307 A (PTL 1) discloses a pest repellent containing carane-3,4-diol and a silicone oil having a viscosity of 5,000 cSt or less at 25° C.

JP 2009-1501 A (PTL 2) discloses a pest repellent for human body, which is a solid composition composed of a pest repellent component, a C2 to C6 alcohol and/or glycol, and a soap paste saponified with at least two selected from a C10 to C22 fatty acid and an alkaline aqueous solution, and further describes blending of a silicone composition soluble in the alcohol and/or glycol.

### SUMMARY OF THE INVENTION

The present invention relates to a pest repellent including, as an active ingredient, at least one liquid oily component selected from the group consisting of a silicone oil, an ester oil, an ether oil, a hydrocarbon oil, an aliphatic higher alcohol having 14 or more carbon atoms, and a polyhydric alcohol, the liquid oily component having a surface tension at 25° C. of 40 mN/m or less and a viscosity at 23° C. as measured with a B-type rotational viscometer of 1,200 mPa·s or less.

### DETAILED DESCRIPTION OF THE INVENTION

As a pest repellent to be applied to the skin, it is desired that when applied to the skin, it has an excellent repellent effect, is safe, and has a low odor. It is the present situation that the currently available major pest repellents do not adequately meet these needs.

For example, a repellent, such as DEET, is an agent that repels a pest by modulating the chemoreceptive system against the pest and neutralizing the cognitive sensation of the pest. However, in consideration of application to infants and people with sensitive skin, safer pest repellents are preferred.

The present invention relates to a pest repellent, a pest repellent composition, and a method for repelling pests, which are excellent in repellent effects against pests, particularly flying pests, and are safe and have a low odor.

The present inventors made investigations regarding the repellent behavior of pests in detail and investigated a repellent for repelling pests and a repellent method by preventing pests, particularly flying pests, such as mosquitoes, from staying on the body surface of an animal, such as humans, livestock, and pets. As a result, they found that when a pest lands on the body surface of the animal, it can utilize properties of hindering a foreign body from attaching to a limb and becoming wet. That is, by applying a substance which has an affinity for the pest limb and easily attaches onto the body surface (skin) of the animal, when the pest lands, the pest limb gets wet (dirty), and an adhesive force (attraction) is generated between the pest limb and a substance on the body surface of the animal. Since the pests dislike this adhesive force (attraction), it was found that the pests immediately fly away even if they land on the body surface of the animal.

Then, in order to find a safe component which has no side effects, such as skin disorders, and which when applied or attached onto the body surface (skin), makes the pest dislike the staying, the present inventors made extensive and intensive investigations. As a result, it has been found that a liquid oily component having specified surface tension and viscosity has high affinity with limbs of pests, such as mosquitoes, and easily contaminates limbs of pests, and thus, the aforementioned problem can be solved.

Specifically, the present invention relates to the following [1] to [3].

[1] A pest repellent including, as an active ingredient, at least one liquid oily component selected from the group consisting of a silicone oil, an ester oil, an ether oil, a hydrocarbon oil, an aliphatic higher alcohol having 14 or more carbon atoms, and a polyhydric alcohol, the liquid oily component having a surface tension at 25° C. of 40 mN/m or less and a viscosity at 23° C. as measured with a B-type rotational viscometer of 1,200 mPa·s or less.
[2] A pest repellent composition containing at least one liquid oily component selected from the group consisting of a silicone oil, an ester oil, an ether oil, a hydrocarbon oil, an aliphatic higher alcohol having 14 or more carbon atoms, and a polyhydric alcohol, the liquid oily component having a surface tension at 25° C. of 40 mN/m or less and a viscosity at 23° C. as measured with a B-type rotational viscometer of 1,200 mPa·s or less, and not containing an effective amount of other pest repellent.
[3] A method for repelling pests, including applying the pest repellent as set forth in the above [1], or the pest repellent composition as set forth in the above [2] onto the skin surface of a human such that the amount of the liquid oily component is 0.1 mg or more per 1 cm².

According to the present invention, a pest repellent, a pest repellent composition, and a method for repelling pests, which are excellent in repellent effect against pests, particularly flying pests, and are safe and have a low odor can be provided.

### [Pest Repellent and Pest Repellent Composition]

The pest repellent of the present invention includes, as an active ingredient, at least one liquid oily component selected from the group consisting of a silicone oil, an ester oil, an ether oil, a hydrocarbon oil, an aliphatic higher alcohol having 14 or more carbon atoms, and a polyhydric alcohol, the liquid oily component having a surface tension at 25° C. of 40 mN/m or less and a viscosity at 23° C. as measured with a B-type rotational viscometer of 1,200 mPa·s or less.

The pest repellent composition of the present invention contains at least one liquid oily component selected from the group consisting of a silicone oil, an ester oil, an ether oil, a hydrocarbon oil, an aliphatic higher alcohol having 14 or more carbon atoms, and a polyhydric alcohol, the liquid oily component having a surface tension at 25° C. of 40 mN/m or less and a viscosity at 23° C. as measured with a B-type rotational viscometer of 1,200 mPa·s or less, and does not contain an effective amount of other pest repellent.

Even when a liquid oily component exceeding the aforementioned viscosity range is concerned, it is possible to repel pests by applying it in a large amount. But, when a large amount of a high-viscosity liquid oily component is applied, inconveniences, such as deterioration of feel due to stickiness, etc. and transfer to clothes, etc., occur, and the high-viscosity liquid oily component is difficult to spread and is poor in workability. Therefore, a liquid oily component exceeding the aforementioned viscosity range is not preferred.

Here, the term “pest repellent” in the present invention means that the pest immediately leaves even if it comes into contact with a target, and the pest repellent or the pest repellent composition of the present invention (hereinafter also collectively referred to as “pest repellent or the like”) is corresponding to a contact repellent. That is, the pest repellent effect of the present invention is different in principle from a conventional repellent that repels a pest such that a pest does not contact with the target, such as one that does not attract the pest to the target and one making the pest not approach the target, and an insecticide having an insecticidal activity against the pest and exterminating the pest.

The pest repellent or the like of the present invention repels pests (suppression of landing) even if the pests, such as mosquitoes, land on the target onto which they are applied or attached, by leaving the pests immediately dislike the place. The pest repellent or the like of the present invention has an effect of preventing a pest, such as a mosquito, from staying in a predetermined area on the body surface of the animal for a time enough to pierce the animal, for example, 1 second or more. Such an effect is based on an unprecedented pest repellent principle, and is safe without side effects. The pest repellent or the like of the present invention can also be used as a pest stay inhibitor.

In this specification, an effect based on the aforementioned novel pest repellent principle is referred to as “repellent effect”, and a method of exhibiting such a repellent effect is referred to as “repellent method”.

Although the pest targeted by the pest repellent or the like of the present invention is not particularly limited, the pest repellent or the like of the present invention is more effective for flying pests.

The “flying pests” refer to pests that approach animals, such as humans, while flying and suck blood from their skin, pests that carry pathogenic bacteria or the like while flying without sucking blood, and pests in which their own flying gives a feeling of displeasure to humans.

Specific examples of the flying pests include mosquitoes, such as Anopheles sinensis, Culex pipiens pallens, Culex tritaeniorhynchus, Aedes aegypti, Culex pipiens molestus, Aedes albopictus, Aedes togoi, Anopheles gambiae, and Anopheles stephensi; chironomidae, such as Chironomus yoshimatsui and Propsilocerus akamusi; black flies, such as Twinnia japonensis, Prosimulium yezoense, and Odagmia aokii; flies, such as Musca domestica, Muscina stabulans, Fannia canicularis, Calliphoridae, Sarcophagidae, Delia platura, Delia antiqua, fruit flies, vinegar flies, moth flies, tsetse flies, and Stomoxys calcitrans; horseflies, such as Tabanus stygius, Tabanus trigonus, Chrysops suavis, and Haematopota pluvialis tristis; biting midges, such as Leptoconops nipponensis, Culicoides sumatrae, and Culicoides arakawae; and bees, such as Vespa simillima xanthoptera, Polistes jokahamae, and honeybees.

The pest repellent or the like of the present invention is particularly excellent in the repellent effect against mosquitoes among them.

The pest repellent or the like of the present invention has an effect as the pest repellent or the like even when it does not contain an effective amount of a repellent active ingredient other than the aforementioned liquid oily component or an existing pest repellent. Even in the case where the pest repellent or the like of the present invention contains a repellent active ingredient other than the aforementioned liquid oily component or existing pest repellent, so long as a repellent effect is exhibited such that the pest is close to or comes in contact with the target and leaves immediately thereafter, the contact repellent effect of the present invention is exhibited. That is, the pest repellent or the like of the present invention may not substantially contain a repellent active ingredient other than the aforementioned liquid oily component or existing pest repellent, but rather, it is preferred that a repellent active ingredient other than the aforementioned liquid oily component or existing pest repellent is not contained.

The pest repellent of the present invention contains the aforementioned liquid oily component as an active ingredient.

The content of the liquid oily component in the pest repellent is preferably 20% by mass or more, more preferably 30% by mass or more, still more preferably 40% by mass or more, yet still more preferably 50% by mass or more, and even yet still more preferably 60% by mass or more, and it is preferably 100% by mass or less, more preferably 90% by mass or less, and still more preferably 80% by mass or less.

The pest repellent of the present invention can appropriately contain commonly used solvents, oils, and additives depending on the form of use.

The pest repellent composition of the present invention contains the aforementioned liquid oily component and does not contain an effective amount of a pest repellent other than the aforementioned liquid oily component.

The content of the aforementioned liquid oily component in the pest repellent composition is preferably 20% by mass or more, more preferably 30% by mass or more, still more preferably 40% by mass or more, yet still more preferably 50% by mass or more, and even yet still more preferably 60% by mass or more.

Here, the phrase “does not contain an effective amount” of the existing pest repellent generally means that the content of the existing pest repellent other than the aforementioned liquid oily component is preferably 15% by mass or less, more preferably 10% by mass or less, still more preferably 5% by mass or less, yet still more preferably 3% by mass or less, even yet still more preferably 2% by mass or less, and even still more preferably 1% by mass or less in the pest repellent composition.

As for the effective amount of the existing pest repellent, for example, the minimum effective amount and the like published by the manufacturer of each repellent product can be made by reference.

More specifically, the effective amount of DEET is 4% by mass or more, and preferably 10% by mass or more; the effective amount of Icaridin is 5% by mass or more; and the effective amount of citronellol is 10% by mass or more, each of these compounds being an existing pest repellent as mentioned later.

The effective amount of the existing pest repellent can also be measured by a repellent evaluation test as mentioned below.

### <Repellent Evaluation Test>

100 female mosquitoes (Aedes albopictus) that have been mated are placed in a plastic cage (30×30×30 cm: BugDorm-1 cage) surrounded by a mesh. An arm is inserted into a KUALATEC Super Long Glove (50 cm) (available from AS ONE Corporation, Catalog No.: 3-6432-02) with a rectangular shape having a size of 5 cm in length×4 cm in width cut on the elbow side of about 15 cm from the wrist. The arm is inserted into the cage in a state that nothing is applied to an exposed skin portion from the cut, and it is confirmed that the mosquitoes land in two locations of the exposed skin portion within 2 minutes and then stay for at least 1 second. In the case where the mosquito does not stay for at least one second, a new mosquito is prepared. The “stay for at least 1 second” is hereinafter referred to simply as “stay”.

The concentration is adjusted with ethanol such that an evaluation sample that is a solution of the pest repellent active ingredient can be applied at a coverage of 2 mg/cm² to the exposed skin portion (5 cm×4 cm).

Using a pipetman, the solution whose concentration has been adjusted is placed in the exposed skin portion and applied so as to spread over the entire exposed skin portion (required solution volume: 40 to 50 μL). Subsequently, after allowing to stand for 3 minutes, the test is started.

The test is performed by inserting the arm applied with the evaluation sample into the cage for 2 minutes and counting the number of stays. The test is terminated when the mosquito has stayed twice in total, and the test is performed in which the arm is inserted for 2 minutes every 30 minutes until the test is completed. In the case where there is a second stay at 30 minutes, the repellent effect duration is determined to be 0 minute, and in the case where there is a second stay at 60 minutes, the repellent effect duration is determined to be 30 minutes. The test is performed on three subjects, and an average repellent effect duration is calculated.

In the present test, the concentration of the pest repellent active ingredient that shows an average repellent effect duration of 2 hours or more can be taken as the effective concentration (effective amount) of the pest repellent active ingredient.

Examples of the pest repellent active component other than the aforementioned liquid oily component or the existing pest repellent include known pest repellent compounds, such as DEET, Icaridin, dimethyl phthalate, 2-ethyl-1,3-hexanediol, p-menthane-3,8-1E01, carane-3,4-diol, di-n-butyl succinate, hydroxyanisole, rotenone, ethyl-butylacetylaminopropionate, citronellol, eucalyptol, α-pinene, geraniol, citronellal, camphor, linalool, and 2-undecanone, and besides, natural essential oils.

Since the natural essential oils do not have a sufficient repellent effect against pests, the pest repellent or the like of the present invention does not contain natural essential oils as an essential active ingredient. However, a natural essential oil can be contained in the pest repellent of the present invention, as the need arises.

Here, the “natural essential oil” means a refined oil (essential oil) obtained by extracting, distilling, compressing or the like a component contained in a plant. Although the natural essential oil is not particularly limited, examples thereof include citronella oil (Cymbopogon nardus), peppermint oil (Mentha piperita), cedarwood oil (Juniperus virginiana), eucalyptus leaf oil, spike lavender oil, tea tree leaf oil, patchouli oil, mentha oil, hinoki cypress oil, Thujopsis dolabrata neutral oil, Thujopsis dolabrata acid oil, pine oil, perilla oil, catnip oil, lavender oil, coriander oil, lime oil, lemongrass oil, neroli oil, hiba oil, thyme oil, hyssop oil, rosemary oil, rose oil, Ylang-ylang oil, pepper oil, cinnamon oil, camphor oil, laurel oil, chamomile oil, mugwort oil, olibanum oil, tarragon oil, vetiver oil, clove oil, bay oil, geranium oil, sage oil, basil oil, parsley oil, star anise oil, fennel oil, manuka oil, galvanum oil, guaiac wood oil, oil of Cnidium officinale, dill oil, violet oil, angelica oil, turmeric oil, ginger oil, ambrette oil, and wintergreen oil.

The pest repellent or the like of the present invention is excellent in repellent effects against pests, particularly flying pests. Although the reason for this is not elucidated yet, the following may be considered.

Flying pests, such as mosquitoes, dislike the adhesive force (attraction) that occurs when wetting occurs, and thus have properties of avoiding contact with surfaces where the limbs become dirty. Since the limbs of flying pests, such as mosquitoes, are hydrophobic, if the oil is a liquid oily component having a surface tension of 40 mN/m or less, the affinity with the limbs of flying pests becomes high, and if the viscosity is 1,200 mPa·s or less, on the occasion of coming into contact with the liquid oily component, the contact area between the limbs of flying pests and the liquid oily component becomes sufficiently large within a short time. Therefore, when the flying pest tries to land on or lands on the body surface of the animal, the limb becomes dirty. Thus, the flying pest dislikes it, and it may be considered that the flying pest does not land or even if the flying pest lands, it jumps off immediately, for example, within one second.

### <Liquid Oily Component>

The liquid oily component which the pest repellent or the like of the present invention contains as the active ingredient is at least one selected from the group consisting of (a) a silicone oil, (b) an ester oil, (c) an ether oil, (d) a hydrocarbon oil, (e) an aliphatic higher alcohol having 14 or more carbon atoms, and (f) a polyhydric alcohol, each of which has a surface tension at 25° C. of 40 mN/m or less and a viscosity at 23° C. as measured with a B-type rotational viscometer of 1,200 mPa·s or less.

The liquid oily component is preferably liquid at 20° C., more preferably liquid at 15° C., and still more preferably liquid at 10° C. from the viewpoint of facilitating application to the skin and improving the repellent effect against pests.

The term “liquid” of the liquid oily component means one which is determined to be a liquid in a liquid-solid determination test according to the American Society for Testing and Materials Standards “ASTM D4359-90: Standard Test Method for Determining Whether a Material is a Liquid for Solid”.

The liquid oily component is preferably a sparingly water-soluble or water-insoluble component from the viewpoint of improving the repellent effect against pests. Specifically, the dissolution amount in 100 g of water at 20° C. is preferably 1 g or less, more preferably 0.5 g or less, and still more preferably 0.1 g or less, and it is preferably 0 g or more.

The surface tension at 25° C. of the liquid oily component to be contained in the pest repellent is preferably 15 mN/m or more, and more preferably 17 mN/m or more, and it is 40 mN/m or less, preferably 35 mN/m or less, more preferably 32 mN/m or less, and still more preferably 30 mN/m or less, from the viewpoint of improving the repellent effect against pests.

The viscosity of the liquid oily component at 23° C. as measured with a B-type rotational viscometer is preferably 5 mPa·s or more from the viewpoint of suppressing volatility, and it is 1,200 mPa·s or less, preferably 800 mPa·s or less, and more preferably 580 mPa·s or less from the viewpoint of suppressing peculiar stickiness which a high-viscosity liquid oily component possesses to facilitate application.

The optimum viscosity of the liquid oily component has a certain range depending on the type of the liquid oil component.

In the case of the silicone oil (a), the aforementioned viscosity is preferably 5 mPa·s or more, more preferably 7 mPa·s or more, and still more preferably 9 mPa·s or more from the viewpoint of suppressing volatility, and it is preferably 900 mPa·s or less, more preferably 700 mPa·s or less, still more preferably 580 mPa·s or less, yet still more preferably 500 mPa·s or less, even yet still more preferably 400 mPa·s or less, even still more preferably 300 mPa·s or less, even still more further preferably 200 mPa·s or less, and even yet still more further preferably 100 mPa·s or less from the viewpoint of suppressing peculiar stickiness which a high-viscosity silicone oil possesses to facilitate application.

In the case of the ester oil (b), the ether oil (c), and the hydrocarbon oil (d), the aforementioned viscosity is preferably 7 mPa·s or more, and more preferably 9 mPa·s or more from the viewpoint of suppressing volatility, and it is preferably 300 mPa·s or less, more preferably 200 mPa·s or less, still more preferably 100 mPa·s or less, yet still more preferably 80 mPa·s, and even yet still more preferably 60 mPa·s or less from the viewpoint of suppressing peculiar stickiness which a high-viscosity liquid oily component possesses to facilitate application.

In the case of the aliphatic higher alcohol (e) having 12 or more carbon atoms and the polyhydric alcohol (f), the aforementioned viscosity is preferably 7 mPa·s or more, more preferably 9 mPa·s or more, and more preferably 50 mPa·s or more from the viewpoint of suppressing volatility, and it is preferably 400 mPa·s or less, more preferably 300 mPa·s or less, and still more preferably 200 mPa·s or less from the viewpoint of suppressing peculiar stickiness which a high-viscosity liquid oily component possesses to facilitate application.

The surface tension and the viscosity of the liquid oily component are measured by the methods described in the section of Examples.

### (a) Silicone Oil

As the silicone oil, at least one selected from dimethylpolysiloxane, dimethiconol (dimethylpolysiloxane having a hydroxy group at the terminal), methylphenylpolysiloxane, modified silicone, and cyclic silicone is preferred from the viewpoint of improving the repellent effect against pests.

Since the silicone oil has low volatility, it is able to maintain the repellent effect against pests over a long period of time.

Examples of the modified silicone include amino-modified silicone (dimethylpolysiloxane having an amino group in a molecule thereof), polyether-modified silicone, glyceryl-modified silicone, amino derivative silicone, carboxy-modified silicone, fatty acid-modified silicone, alcohol-modified silicone, aliphatic alcohol-modified silicone, epoxy-modified silicone, fluorine-modified silicone, and alkyl-modified silicone.

Of the silicone oils, at least one selected from dimethylpolysiloxane, dimethiconol, methylphenylpolysiloxane, and modified silicone is preferred from the viewpoint of suppressing volatility. At least one selected from dimethylpolysiloxane, dimethiconol, and polyether-modified silicone is more preferred, and dimethylpolysiloxane is still more preferred from the viewpoint of low density, namely from the viewpoint that even in the case where a specified amount of the silicone oil is applied onto the body surface, the volume of the silicone oil which can be applied onto that surface can be increased.

As mentioned above, the viscosity of the silicone oil at 23° C. is preferably 5 mPa·s or more, and more preferably 9 mPa·s or more from the viewpoint of suppressing volatility, and it is preferably 900 mPa·s or less, more preferably 700 mPa·s or less, still more preferably 580 mPa·s or less, yet still more preferably 500 mPa·s or less, even yet still more preferably 400 mPa·s or less, even still more preferably 300 mPa·s or less, even still more further preferably 200 mPa·s or less, and even yet still more further preferably 100 mPa·s or less from the viewpoint of suppressing stickiness peculiar to high viscosity to facilitate application.

In the case of using two or more silicone oils having a different viscosity from each other, the viscosity of a silicone oil mixture is meant.

Examples of the dimethylpolysiloxane include at least one selected from a linear dimethylpolysiloxane and a cyclic dimethylpolysiloxane. Of these, the linear dimethylpolysiloxane is more preferred from the viewpoint of improving the repellent effect against pests.

Examples of a commercially available product of the linear dimethylpolysiloxane include KF-96 Series, manufactured by Shin-Etsu Chemical Co., Ltd.; SH200C Series, 2-1184 Fluid, manufactured by Dow Corning Toray Co., Ltd.; and Silsoft DML, Element 14 PDMS 5-JC, Element 14 PDMS 10-JC, and Element 14 PDMS 20-JC, all of which are manufactured by Momentive Performance Materials, Inc.

### (b) Ester Oil

As the ester oil, any of ester oils represented by the following general formulae (1) to (3) and a dialkyl carbonate compound represented by the following general formula (4) are preferred.

R¹—COO—R² (1)

In the general formula (1), R¹ represents a linear or branched alkyl group having 7 or more and 22 or less carbon atoms, which may be substituted with a hydroxy group, or an aromatic hydrocarbon group having 6 or more and 24 or less carbon atoms; and R² represents a linear or branched alkyl group or alkenyl group having 1 or more and 22 or less carbon atoms.

In the case where R¹ is an alkyl group, the carbon number thereof is preferably 8 or more, and more preferably 10 or more, and it is preferably 20 or less, and more preferably 18 or less. In addition, in the case where R¹ is an aromatic hydrocarbon group, the carbon number thereof is preferably 8 or more, and more preferably 10 or more, and it is preferably 22 or less, and more preferably 20 or less.

R² is a linear or branched alkyl group or alkenyl group having preferably 20 or less carbon atoms, and more preferably 18 or less carbon atoms. In addition, it is preferred that at least one of R¹ and R² is a branched alkyl group.

Examples of the ester oil represented by the general formula (1) is at least one selected from myristyl 2-ethylhexanoate, cetyl 2-ethylhexanoate, stearyl 2-ethylhexanoate, isodecyl octanoate, isocetyl octanoate, isononyl isononanoate, isotridecyl isononanoate, cetearyl isononanoate, octyl propylheptanoate, methyl laurate, isopropyl myristate, octyldodecyl myristate, isopropyl palmitate, 2-ethylhexyl palmitate, isocetyl palmitate, 2-ethylhexyl stearate, isocetyl stearate, isotridecyl stearate, isopropyl isostearate, octyl isostearate, isocetyl isostearate, isostearyl isostearate, 2-ethylhexyl hydroxystearate, methyl oleate, oleyl oleate, isobutyl oleate, oleyl erucate, an alkyl benzoate (carbon number of alkyl: 12 to 15), and diethylhexyl naphthalenedicarboxylate.

(R³O)—CH₂CH(OR⁴)—CH₂(OR⁵) (2)

In the general formula (2), R³, R⁴, and R⁵ are each independently a hydrogen atom or a group represented by the following general formula (2-1), provided that all of them are not a hydrogen atom at the same time.

—CO—R⁶ (2-1)

In the formula, R⁶ represents an alkyl group or alkenyl group having 8 or more and 22 or less carbon atoms, and preferably 18 or less carbon atoms, which may be substituted with a hydroxy group.

Examples of the ester oil represented by the general formula (2) include at least one selected from glyceryl tri-2-ethylhexanoate, glyceryl tricaprylate, jojoba oil, olive oil, sunflower oil, soybean oil, peanut oil, rapeseed oil, almond oil, palm oil, coconut oil, castor oil, wheat germ oil, grape seed oil, thistle oil, evening primrose oil, macadamia nut oil, corn germ oil, and avocado oil.

R⁷O-(AO)ₘ—COR⁸ (3)

In the general formula (3), R⁷ represents an aromatic hydrocarbon group having 6 or more and 20 or less carbon atoms; R⁸ represents an alkyl group or alkenyl group having 2 or more and 25 or less carbon atoms; AO represents an alkyleneoxy group having 2 or more and 4 or less carbon atoms; and an average addition molar number m is a number of 1 or more and 50 or less.

R⁷ is an aromatic hydrocarbon group having preferably 6 or more carbon atoms and preferably 12 or less carbon atoms, and more preferably 10 or less carbon atoms, and more preferably a benzyl group.

R⁸ is an alkyl group having preferably 7 or more carbon atoms, and more preferably 11 or more carbon atoms, and preferably 21 or less carbon atoms, and more preferably 15 or less carbon atoms.

The AO group is preferably a propyleneoxy group; and m is preferably 1 or more and 10 or less, and more preferably 1 or more and 5 or less.

Examples of the ester oil represented by the general formula (3) include at least one selected from an ester of a propylene oxide 3 mol adduct of benzyl alcohol and myristic acid (CRODAMOL STS, manufactured by Croda) and an ester of a propylene oxide 3 mol adduct of benzyl alcohol and 2-ethylhexanoic acid (CRODAMOL SFX, manufactured by Croda).

R⁹—O—(CH₂CH₂O)ᵥ—CO—(OCH₂CH₂)_{w}—OR¹⁰ (4)

In the general formula (4), R⁹ and R¹⁰ each independently represent an alkyl group or alkenyl group having 6 or more and 22 or less carbon atoms; and v and w are each independently 0 or a number of 1 or more and 50 or less.

R⁹ and R¹⁰ are each an alkyl group having preferably 8 or more carbon atoms and preferably 18 or less carbon atoms, and more preferably 12 or less carbon atoms.

v and w are each preferably 0 or a number of 1 or more and 5 or less, and more preferably 0.

Examples of the dialkyl carbonate compound represented by the general formula (4) include dioctyl carbonate (Cetiol CC, manufactured by Cognis).

Examples of ester oils other than those mentioned above include an ester of a polyvalent carboxylic acid and an alcohol; and an ester of a polyhydric alcohol excluding glycerin and a fatty acid.

Specific examples thereof include at least one selected from diisopropyl dimerate, diisopropyl adipate, diethoxyethyl succinate, 2-ethylhexyl succinate, propanediol dicaprate, neopentyl glycol dicaprate, and neopentyl glycol di-2-ethylhexanoate. Of these, an ester of neopentyl glycol and a fatty acid is preferred, and at least one selected from neopentyl glycol dicaprate and neopentyl glycol di-2-ethylhexanoate is more preferred.

Of the aforementioned ester oils (b), at least one selected from the ester oil represented by the general formula (1) and an ester of neopentyl glycol and a fatty acid are preferred.

### (c) Ether Oil

As the ether oil, a dialkyl ether compound represented by the following general formula (5), a polyoxyalkylene alkyl ether compound represented by the following general formula (6), or a polyoxyalkylene glycol is preferred from the viewpoint of improving the repellent effect against pests.

R¹¹—O—R¹² (5)

In the general formula (5), R¹¹ and R¹² each independently represent a linear or branched alkyl group or alkenyl group having 6 or more and 22 or less carbon atoms or an aromatic hydrocarbon group having 6 or more and 24 or less carbon atoms.

R¹¹ and R¹² are each preferably an alkyl group, and the carbon number thereof is preferably 8 or more, and it is preferably 18 or less, and more preferably 12 or less.

Examples of the dialkyl ether compound represented by the general formula (5) include dihexyl ether, dioctyl ether (Cetiol OE, manufactured by Cognis), dicaprylyl ether, and cetyl-1,3-dimethylbutyl ether.

R¹³—O—(PO)ᵣ(EO)ₛ—H (6)

In the general formula (6), R¹³ represents an alkyl group or alkenyl group having 6 or more and 22 or less carbon atoms; PO represents a propyleneoxy group; EO represents an ethyleneoxy group; an average addition molar number r is 0.1 or more and 15 or less; and an average addition molar number s is 0 or more and 10 or less. In the case where s is not 0, an addition form of each of PO and EO may be a random form or may be a block form.

The carbon number of R¹³ is preferably 8 or more, and it is preferably 20 or less, more preferably 18 or less, and still more preferably 12 or less.

The average addition molar number r is preferably 1 or more, more preferably 2 or more, and still more preferably 3 or more, and it is preferably 13 or less, and more preferably 10 or less; and the average addition molar number s is preferably 5 or less, more preferably 1 or less, and still more preferably 0.

As the polyoxyalkylene alkyl ether compound represented by the general formula (6), at least one selected from polyoxypropylene octyl ether, polyoxypropylene decyl ether, and polyoxypropylene lauryl ether, in which the average addition molar number r of the propyleneoxy group is 3 or more and 10 or less, is preferred.

Examples of the polyalkylene glycol include a polymer of ethylene glycol, a polymer of propylene glycol, a polymer of butylene glycol, a copolymer of ethylene glycol and propylene glycol, a copolymer of ethylene glycol and butylene glycol, a copolymer of propylene glycol and butylene glycol, and a copolymer of ethylene glycol, propylene glycol, and butylene glycol. An addition form of the aforementioned copolymer may be a random form or may be a block form, and it may be alone or in admixture of two or more thereof so long as the surface tension at 25° C. is 40 mN/m or less, and the viscosity at 23° C. as measured with a B-type rotational viscometer is 1,200 mPa·s or less. In addition, it may be a diol type or may be a triol type, with a diol type being preferred.

An average molecular weight of the polyalkylene glycol is preferably 300 or more, more preferably 400 or more, still more preferably 600 or more, and yet still more preferably 800 or more, and it is preferably 5,000 or less, more preferably 4,000 or less, still more preferably 3,000 or less, and yet still more preferably 2,000 or less, from the viewpoint of improving the repellent effect against pests.

The polyalkylene glycol is preferably a polymer of propylene glycol, namely polypropylene glycol.

Of the aforementioned ether oils (c), the dialkyl ether compound represented by the general formula (5) is preferred.

### (d) Hydrocarbon Oil

The hydrocarbon oil is preferably a saturated or unsaturated hydrocarbon having 16 or more carbon atoms, and more preferably a saturated or unsaturated hydrocarbon having 20 or more carbon atoms from the viewpoint of improving the repellent effect against pests.

Examples of the hydrocarbon oil include a liquid paraffin, a liquid isoparaffin, squalane, isohexadecane, isoeicosane, hydrogenated polyisobutene, a light liquid isoparaffin, a heavy liquid isoparaffin, an α-olefin oligomer, and a cycloparaffin.

Of these, at least one selected from a liquid paraffin, a liquid isoparaffin, and squalane is preferred.

### (e) Aliphatic Higher Alcohol Having 14 or More Carbon Atoms

Examples of the aliphatic higher alcohol having 14 or more carbon atoms include an aliphatic higher alcohol having preferably 16 or more carbon atoms, and more preferably 18 or more carbon atoms, and preferably 28 or less carbon atoms, more preferably 26 or less carbon atoms, and still more preferably 24 or less carbon atoms, from the viewpoint of improving the repellent effect against pests.

Although the aforementioned higher alcohol may be any of a linear higher alcohol and a branched higher alcohol, and it may be any of a saturated higher alcohol and an unsaturated higher alcohol, it is preferably a linear or branched saturated higher alcohol.

Examples of the linear saturated higher alcohol include myristyl alcohol, cetyl alcohol, stearyl alcohol, an aralkyl alcohol, behenyl alcohol, and carnaubyl alcohol; and examples of the branched saturated higher alcohol include butyl octanol, hexyl octanol, butyl decanol, hexyl decanol, hexyl dodecanol, and octyl dodecanol.

Of these, an aliphatic branched saturated higher alcohol is preferred; at least one selected from hexyl decanol, hexyl dodecanol, and octyl dodecanol is more preferred; and at least one selected from hexyl dodecanol and octyl dodecanol is still more preferred.

### (f) Polyhydric Alcohol

Examples of the polyhydric alcohol include at least one selected from an aliphatic alcohol having 4 or more carbon atoms, an aromatic alcohol, and a sugar alcohol having 4 or more carbon atoms, and the polyhydric alcohol may be either saturated or unsaturated.

Preferred examples of the polyhydric alcohol include at least one dihydric alcohol having 4 or more and 6 or less carbon atoms and selected from 1,2-butylene glycol, 1,3-butylene glycol, 1,2-pentanediol, 1,2-hexanediol, diethylene glycol, dipropylene glycol, hexylene glycol, etc.

Examples of the sugar alcohol include sorbitol, pentaerythritol, xylitol, and mannitol. Among the polyhydric alcohols, one having a high surface tension exhibits the repellent effect if its surface tension is reduced as a polyhydric alcohol mixture.

Of the aforementioned liquid oily components, from the viewpoint of improving the repellent effect against pests, at least one selected from the silicone oil (a), the ester oil (b), the ether oil (c), the hydrocarbon oil (d), and the polyhydric alcohol (f) is preferred; at least one selected from the silicone oil (a), the ester oil (b), the ether oil (c), and the hydrocarbon oil (d) is more preferred; at least one selected from the silicone oil (a), the ester oil (b), and the hydrocarbon oil (d) is still more preferred; at least one selected from the silicone oil (a) and the ester oil (b) is yet still more preferred; and the silicon (a) is even yet still more preferred.

[Form, Etc. Of Pest Repellent or the Like]

Although, the pest repellent or the like of the present invention can be used as it is without being diluted with a solvent or the like, it can also be used by being appropriately blended with a solvent, an oil, or an additive which is generally used for cosmetics or the like, according to the use form and purpose.

The use form of the pest repellent or the like of the present invention is not particularly restricted. Examples of the use form include an arbitrary form, such as a mist form, a liquid form, a foam form, a paste form, and a cream form. Of these, a liquid form, a paste form, or a cream form is preferred, and a liquid form is more preferred.

The pest repellent or the like of the present invention can be produced by a conventional method according to the use form.

Furthermore, the pest repellent or the like of the present invention can also be used as a material for imparting a pest repellent activity to skin external agents, skin cosmetics, and the like.

### [Method for Repelling Pests]

The method for repelling pests of the present invention is a method including applying the pest repellent or the like of the present invention onto the skin surface such that the amount of the liquid oily component is 0.1 mg or more per 1 cm².

Here, the phrase “applying onto the skin surface” includes not only directly applying the liquid oily component onto the skin surface by a finger or the like but also attaching the liquid oily component onto the skin surface by spraying or the like.

When the pest repellent or the like is in a liquid form, a foam form, a paste form, or a cream form, it can be usually applied as it is by application, spraying, or the like.

The amount of the liquid oily component which is applied onto the skin surface is 0.1 mg or more, preferably 0.2 mg or more, and more preferably 0.25 mg or more per 1 cm² from the viewpoint of improving the repellent effect against pests. In addition, an upper limit of the application amount is preferably 3 mg or less, more preferably 2 mg or less, still more preferably 1 mg or less, yet still more preferably 0.8 mg or less, and even yet still more preferably 0.6 mg or less per 1 cm² from the viewpoint of suppression of stickiness and economy.

In accordance with the method for repelling pests of the present invention, by attaching the pest repellent or the like of the present invention onto limbs of pests, particularly flying pests, the pests can be prevented from staying on the skin surface of a human.

The method for repelling pests of the present invention is a method in which even if a pest, such as a mosquito, lands on the target onto which the pest repellent or the like has been applied or attached, the pest dislikes that place and immediately leaves, so that the pest is repelled. The method for repelling pests of the present invention has an effect of preventing a pest, such as a mosquito, from staying in a predetermined area on the body surface of the animal for a time enough to pierce the animal, for example, 1 second or more. Such an effect is based on an unprecedented pest repellent principle and is safe without side effects.

### EXAMPLES

The measurement of the surface tension and viscosity of the liquid oily component and the evaluation of the mosquito landing rate were performed by the following methods.

### (1) Measurement of Surface Tension

An automatic surface tensiometer: Tensiometer K100 (manufactured by KRUSS GmbH) was used to measure the static surface tension by the Wilhelmy method using a platinum plate in an environment at 25° C.

### (2) Measurement of Viscosity

Viscometer TVB-10, manufactured by Told Sangyo Co., Ltd. was used as a B-type rotational viscometer according to JIS K7117-1:1999. As to components to be measured, a viscosity value greatly differs for every sample, and therefore, it is difficult to accurately measure all components under a single measurement condition. Then, the measurement was performed using two types of rotors. The viscosity was first measured at a rotational speed of 12 rpm using a rotor M2 in an environment at 23° C. At this time, the component having a viscosity of 2,500 mPa·s or more was again measured at a rotational speed of 6 rpm, to obtain the viscosity value.

On the other hand, the component having a viscosity of 20 mPa·s or less was again measured at a rotational speed of 30 rpm using an L adapter that is a rotor for low viscosity in an environment of 23° C., to obtain the viscosity value.

### (3) Mosquito Landing Rate

The repellent effect of the pest repellent was evaluated in terms of a mosquito landing rate.

(3-1) Preparation of Aedes albopictus

Female adults of Aedes albopictus were purchased from Mostop Inc. The adults were bred in a room at 28° C. and a relative humidity of 70% RH with a 12-hour light/dark cycle after delivery and appropriately used for tests. During breeding of mosquitoes, a 3% by mass sucrose aqueous solution was given as a feed.

### (3-2) Measurement of Stay Time of Mosquito on Repellent Applied Surface Using High-Speed Camera

Onto a polyurethane-made replica skin substrate imitating a human skin surface shape using a silicone oil a2 used in Example 2 (No. 10C, manufactured by Beaulax Co., Ltd., hardness: 2LV, color: #BS), a repellent was uniformly applied with a fingertip wearing a rubber glove. It was mounted vertically on an acrylic plate. An acrylic box having a length of 1.4 cm, a width of 5.4 cm, and a height of 3.7 cm and having one open side was prepared, and a test was performed by bringing the open side into contact with the aforementioned replica skin substrate. According to this, one surface inside the acrylic box becomes a replica skin surface. The mosquitoes were released into the acrylic box before the test. A heater was installed on the back of the acrylic plate, and the temperature of the replica skin surface was adjusted to 32° C.

Using this experimental system, the stay time of mosquito was measured by a high-speed camera (Mini UX, manufactured by Photron Limited). The shutter speed was set to 1,000 fps, and a light of 850 nm was used as a light source. The stay time of mosquito was examined by three mosquitoes, respectively. As a result, the stay time of mosquito was 0.1 to 0.2 seconds, and the mosquito did not stay over 0.2 seconds or more on the surface applied with the silicone oil a2.

### (3-3) Calculation of Mosquito Landing Rate

The mosquito landing rate was determined by applying a repellent onto the aforementioned replica skin substrate in the manner as mentioned below to form a substrate surface, counting the number of mosquitoes landed on the substrate surface, and calculating the mosquito landing rate on the applied surface. This replica skin substrate is a disk having a diameter of 5 cm. Here, the term “landed” means that the mosquito stayed on the replica skin substrate for at least one second. This is because the mosquito starts to bite within a few seconds after landing on the skin, so that if it stays for one or more seconds, it can be determined that the repellent effect could not be exhibited.

Four replica skin substrates were prepared, two of which were uniformly applied with a repellent with a fingertip wearing a rubber glove, and the other two were not applied with the repellent. Thereafter, the four substrates were vertically mounted in a glass box having a length, a width, and a height of about 6 cm on each side, such that the applied surface was located inside the boxy. This box has a circular hole with a diameter of 4 cm in the vertical and horizontal directions when viewed from the top, and by setting the aforementioned substrate, a part of the inner wall surface of the box can be made as the substrate surface. Two adjacent surfaces among the four surfaces of the inner wall of the box were set as substrates onto which the repellent was applied.

Four mosquitoes were enclosed in the glass-made box, and a shock was applied to force the mosquitoes to fly, thereby recording on what surface they first landed within 10 seconds. This was repeated 20 times, and the mosquito landing rate on the applied surface was calculated by the following equation. Mosquitoes that landed on other place than the substrate and mosquitoes that did not land within 10 seconds were not counted.

Mosquito landing rate on applied surface (%)={(Number of mosquitoes landed on two surfaces of replica skin substrates applied with repellent)/(Number of mosquitoes landed on any of four surfaces of replica skin substrates)}×100

In the case of repeating the aforementioned test, fresh unused mosquitoes were used for every test, and the landing rate was calculated as an average.

It is expressed that as the landing rate is lower, the staying of mosquitoes can be suppressed, and the repellent effect is excellent.

In Comparative Example 2, a frosted glass-made substrate (Tempax #240, manufactured by Cosmode Co., Ltd.) was used in place of the replica skin substrate. This is because the 1,3-propanediol used in Comparative Example 2 did not spread on the polyurethane-made replica skin substrate.

### (4) Evaluation of Mosquito Landing Rate Using Human Forearm

The repellent effect of the pest repellent on human forearm was evaluated in terms of a mosquito landing rate.

(4-1) Preparation of Aedes albopictus

Female adults of Aedes albopictus were purchased from Mostop Inc. The adults were bred in a room at 28° C. and a relative humidity of 70% RH with a 12-hour light/dark cycle after delivery and appropriately used for tests. During breeding of mosquitoes, a 3% by mass sucrose aqueous solution was given as a feed. In order to facilitate the induction to the forearm, before the test, the food was changed to water, and the mosquitoes were fasted for 12 hours or more.

### (4-2) Calculation of Landing Rate

The forearm was washed with a body wash (Biore u, manufactured by Kao Corporation), and water droplets were wiped off with a paper towel, followed by performing acclimatization for 10 minutes at room temperature. Thereafter, a rubber glove (Singer Latex Long Glove M, manufactured by Utsunomiya Seisakusho Co., Ltd.) covering up to the elbow was put on the arm to be measured. The mosquito cannot bite through the rubber glove.

The rubber glove was cut off with scissors to expose a test site of 4 cm×5 cm toward the inside of the forearm. The area around the opening of the rubber glove is reinforced with a pressure-sensitive adhesive tape. Then, the resultant was moved to a constant temperature and constant humidity room (28° C., relative humidity: 70%), followed by performing acclimatization for 3 minutes. 5 mg (0.25 mg/cm²) of the repellent was applied on the test site with a finger wearing the rubber glove, and immediately thereafter, the arm was inserted into a test box (Bug Dorm-1, manufactured by MegaView Science Co., Ltd., 30 cm×30 cm×30 cm). Approximately 50 test mosquitoes are released in this test box. The mosquito stays on the skin and then begins to bite by placing a needle on the skin. In order to prevent blood sucking into the forearm, mosquitoes are removed by using an inset suction pipe passed through a hole into which the arm is inserted just before starting biting. The measurement was terminated at the time when the total number of mosquitoes that succeeded in landing (reached just before the start of biting) and mosquitoes that touched the skin but escaped without landing reached 15. If the number did not reach 15, the measurement was terminated after a lapse of 5 minutes. The mosquito landing rate was calculated by the following equation.

Mosquito landing rate (%) on the applied surface of forearm=[(Number of mosquitoes landed on the test site)/{(Number of mosquitoes landed on the test site)+(Number of mosquitoes touched the test site but escaped)}]×100

After termination of the measurement, the rubber glove was removed, and the applied portion was washed with the aforementioned body wash. This test was performed on seven types of repellents, but all were performed using the same mosquitoes. The measurement was performed at intervals of about one hour, and the evaluation was performed for two days.

### Examples 1 to 18 and Comparative Examples 1 to 2

The liquid oily component shown in Table 1 was prepared, and the liquid oily component shown in Table 2 was uniformly applied onto the aforementioned replica skin substrate at a coverage of 0.5 mg/cm², and the mosquito landing rate was calculated. The results are shown in Table 2.

### Example 19

The mosquito landing rate was calculated in the same manner as in Example 1, except that in Example 1, a component obtained by mixing polypropylene glycol that is the ether oil (“Polypropylene Glycol, Diol Type, 1000”, manufactured by FUJIFILM Wako Pure Chemical Corporation) and 1,3-butylene glycol (“1,3-Butanediol”, manufactured by FUJIFILM Wako Pure Chemical Corporation) in a mass ratio of 3/7 was used as the liquid oily component. The results are shown in Table 2.

### Examples 20 to 27

In Example 1, each of the liquid oily components shown in Table 3 was uniformly applied onto the replica shin substrate at a coverage of 0.25 mg/cm², and the mosquito landing rate was calculated. The results are shown in Table 3.

### Example 28

The mosquito landing rate was calculated in the same manner as in Example 20, except that in Example 20, a component obtained by mixing polypropylene glycol that is the ether oil (“Polypropylene Glycol, Diol Type, 1000”, manufactured by FUJIFILM Wako Pure Chemical Corporation) in place of the silicone oil a1 and 1,3-butylene glycol that is the polyhydric alcohol (“1,3-Butanediol”, manufactured by FUJIFILM Wako Pure Chemical Corporation) in a mass ratio of 3/7 was used as the liquid oily component. The results are shown in Table 3.

TABLE 1

| | | | | Surface | | | |
|---|---|---|---|---|---|---|---|
| | | | | tension | Viscosity | | |
| Liquid oily | Name of | | | (at 25° C.) | (at 23° C.) | | |
| component | pharmaceutical component | Manufacturer | Trade name | [mN/m] | [mPa · s] | Rotor | (rpm) |
| Silicone oil a1 | Dimethylpolysiloxane | Shin-Etsu Chemical | Silicone KF- | 19 | 5 | L Adaptor | 30 |
| | | Co., Ltd. | 96A-6cs | | | | |
| Silicone oil a2 | Dimethylpolysiloxane | Shin-Etsu Chemical | Silicone KF- | 21 | 60 | M2 | 12 |
| | | Co., Ltd. | 96-50cs | | | | |
| Silicone oil a3 | Dimethylpolysiloxane | Shin-Etsu Chemical | Silicone KF- | 21 | 210 | M2 | 12 |
| | | Co., Ltd. | 96-200cs | | | | |
| Silicone oil a4 | Dimethylpolysiloxane | Shin-Etsu Chemical | Silicone KF- | 21 | 560 | M2 | 12 |
| | | Co., Ltd. | 96-500cs | | | | |
| Silicone oil a5 | Polyoxyethylene/methyl | Shin-Etsu Chemical | Silicone KF- | 21 | 170 | M2 | 12 |
| | polysiloxane copolymer | Co., Ltd. | 6015 | | | | |
| Ester oil b1 | Isononyl isononanoate | The Nisshin OilliO | Saracos 99 | 25 | 6 | L Adaptor | 30 |
| | | Group, Ltd. | | | | | |
| Ester oil b2 | Isotridecyl isononanoate | The Nisshin OilliO | Saracos 913 | 28 | 11 | L Adaptor | 30 |
| | | Group, Ltd. | | | | | |
| Ester oil b3 | Neopentyl glycol | The Nisshin OilliO | Cosmol 525 | 28 | 12 | L Adaptor | 30 |
| | di-2-ethylhexanoate | Group, Ltd. | | | | | |
| Ester oil b4 | Isopropyl palmitate | Kao Corporation | Exceparl IPP | 27 | 7 | L Adaptor | 30 |
| Ester oil b5 | Isopropyl myristate | Kao Corporation | Exceparl IPM | 28 | 5 | L Adaptor | 30 |
| Ester oil b6 | Neopentyl glycol dicaprate | The Nisshin OilliO | Estemol N-01 | 28 | 15 | L Adaptor | 30 |
| | | Group, Ltd. | | | | | |
| Ester oil b7 | Alkyl benzoate | Innospec Active | Finsolv TN | 25 | 12 | L Adaptor | 30 |
| | (alkyl: C12 to 15) | | | | | | |
| Ether oil c1 | Cetyl-1,3-dimethylbutyl ether | Chemicals LLC | | 28 | 7 | L Adaptor | 30 |
| Hydrocarbon oil d1 | Liquid paraffin | Kaneda Co., Ltd. | Hicall K-230 | 27 | 19 | L Adaptor | 30 |
| Hydrocarbon oil d2 | Liquid isoparaffin | NOF Corporation | Parleam EX | 28 | 14 | L Adaptor | 30 |
| Hydrocarbon oil d3 | Squalene | Nippon Surfactant | Nikkol Squalane | 30 | 42 | M2 | 12 |
| | | Industries Co., Ltd. | | | | | |
| Higher alcohol e1 | 2-Octyl dodecanol | BASF SE | Eutanol GJ-P | 29 | 74 | M2 | 12 |
| Polyhydric | Polypropylene glycol/ | FUJIFILM Wako | | 34 | 160 | M2 | 12 |
| alcohol f1 | 1,3-butylene glycol (mixture | Pure Chemical | | | | | |
| | having a mass ratio of 3/7) | Corporation | | | | | |
| Silicone oil ax1 | Dimethylpolysiloxane | Shin-Etsu Chemical | Silicone KF- | 21 | 1100 | M2 | 12 |
| | | Co., Ltd. | 96-1000cs | | | | |
| Silicone oil ax2 | Dimethylpolysiloxane | Shin-Etsu Chemical | Silicone KF- | 21 | 4500 | M2 | 6 |
| | | Co., Ltd. | 96-5000cs | | | | |
| Ester oil bxl | Polyglyceryl cliisostearate | The Nisshin OilliO | Cosmol 42V | 27 | 1000 | M2 | 12 |
| | | Group, Ltd. | | | | | |
| Hydrocarbon oil dx1 | Liquid isoparaffin/ | NOF Corporation | Parleam EX/ | 29 | 2200 | M2 | 12 |
| | heavy liquid | | Parleam 24 | | | | |
| | isoparaffin (mixture | | (mixture having | | | | |
| | having a mass ratio of 4/6) | | a mass ratio of 4/6) | | | | |
| Polyhydric | 1,3-Propanediol | FUJIFILM Wako | | 48 | 53 | M2 | 12 |
| alcohol fx1 | | Pure Chemical | | | | | |
| | | Corporation | | | | | |
| Polyhydric | Glycerin | Kao Corporation | Purified Glycerin | 65 | 950 | M2 | 12 |
| alcohol fx2 | | | | | | | |

TABLE 2

| | | | Surface | | | |
|---|---|---|---|---|---|---|
| | | | tension | Viscosity | | Landing rate |
| | Liquid oily | Name of | (at 25° C.) | (at 23° C.) | | (at 0.5 mg/cm²) |
| | component | pharmaceutical component | [mN/m] | [mPa · s] | (rpm) | [%] |
| Example 1 | Silicone oil a1 | Dimethylpolysiloxane | 19 | 5 | 30 | 9 |
| Example 2 | Silicone oil a2 | Dimethylpolysiloxane | 21 | 60 | 12 | 11 |
| Example 3 | Silicone oil a3 | Dimethylpolysiloxane | 21 | 210 | 12 | 13 |
| Example 4 | Silicone oil a4 | Dimethylpolysiloxane | 21 | 560 | 12 | 15 |
| Example 5 | Silicone oil a5 | Polyoxyethylene/methyl | 21 | 170 | 12 | 11 |
| | | polysiloxane copolymer | | | | |
| Example 6 | Silicone oil ax1 | Dimethylpolysiloxane | 21 | 1100 | 12 | 20 |
| Example 7 | Ester oil b1 | Isononyl isononanoate | 25 | 6 | 30 | 22 |
| Example 8 | Ester oil b2 | Isotridecyl isononanoate | 28 | 11 | 30 | 15 |
| Example 9 | Ester oil b3 | Neopentyl glycol | 28 | 12 | 30 | 12 |
| | | di-2-ethylhexanoate | | | | |
| Example 10 | Ester oil b4 | Isopropyl palmitate | 27 | 7 | 30 | 19 |
| Example 11 | Ester oil b5 | Isopropyl myristate | 28 | 5 | 30 | 11 |
| Example 12 | Ester oil b6 | Neopentyl glycol dicaprate | 28 | 15 | 30 | 20 |
| Example 13 | Ester oil b7 | Alkyl benzoate | 25 | 12 | 30 | 9 |
| | | (alkyl: C12 to 15) | | | | |
| Example 14 | Ester oil bx1 | Polyglyceryl diisostearate | 27 | 1000 | 12 | 21 |
| Example 15 | Ether oil c1 | Cetyl-1,3-dimethylbutyl ether | 28 | 7 | 30 | 13 |
| Example 16 | Hydrocarbon oil d1 | Liquid paraffin | 27 | 19 | 30 | 6 |
| Example 17 | Hydrocarbon oil d2 | Liquid isoparaffin | 28 | 14 | 30 | 12 |
| Example 18 | Hydrocarbon oil d3 | Squalene | 30 | 42 | 12 | 21 |
| Example 19 | Polyhydric alcohol f1 | Polypropylene glycol/ | 34 | 160 | 12 | 15 |
| | | 1,3-butylene glycol | | | | |
| | | (mixture having a | | | | |
| | | mass ratio of 3/7) | | | | |
| Comparative | Silicone oil ax2 | Dimethylpolysiloxane | 21 | 4500 | 6 | 37 |
| Example 1 | | | | | | |
| Comparative | Polyhydric alcohol fx1 | 1,3-Propanediol | 48 | 53 | 12 | 39 |
| Example 2 | | | | | | |

It is noted from Table 2 that in the case of regulating the application amount of the repellent to 0.5 mg/cm², according to the repellents of the Examples, the mosquito landing rate is low as 22% or less, so that the excellent repellent effect is exhibited.

On the other hand, it is noted that in the repellents of the Comparative Examples, the mosquito landing rate is 37% or more, so that the repellent effect is insufficient.

TABLE 3

| | | | Surface | | | |
|---|---|---|---|---|---|---|
| | | | tension | Viscosity | | Landing rate |
| | Liquid oily | Name of | (at 25° C.) | (at 23° C.) | | (at 0.25 mg/cm²) |
| | component | pharmaceutical component | [mN/m] | [mPa · s] | (rpm) | [%] |
| Example 20 | Silicone oil a1 | Dimethylpolysiloxane | 19 | 5 | 30 | 12 |
| Example 21 | Silicone oil a2 | Dimethylpolysiloxane | 21 | 60 | 12 | 10 |
| Example 22 | Silicone oil a3 | Dimethylpolysiloxane | 21 | 210 | 12 | 18 |
| Example 23 | Silicone oil a4 | Dimethylpolysiloxane | 21 | 560 | 12 | 17 |
| Example 24 | Ester oil b5 | Isopropyl myristate | 28 | 5 | 30 | 11 |
| Example 25 | Ester oil b7 | Alkyl benzoate | 25 | 12 | 30 | 14 |
| | | (alkyl: C12 to 15) | | | | |
| Example 26 | Hydrocarbon oil d1 | Liquid paraffin | 27 | 19 | 30 | 17 |
| Example 27 | Higher alcohol e1 | 2-Octyl dodecanol | 29 | 74 | 12 | 16 |
| Example 28 | Polyhydric alcohol f1 | Polypropylene glycol/ | 34 | 160 | 12 | 26 |
| | | 1,3-butylene glycol | | | | |
| | | (mixture having a | | | | |
| | | mass ratio of 3/7) | | | | |

It is noted from Table 3 that in the case of regulating the application amount of the repellent to 0.25 mg/cm², according to the repellents of the Examples, the mosquito landing rate is low as 26% or less, so that the excellent repellent effect is exhibited.

### Examples 29 to 33 and Comparative Examples 3 to 4

Each of the liquid oily components shown in Table 4 was applied onto the test site of the human forearm at a coverage of 0.25 mg/cm², and the mosquito landing rate on the applied surface of the forearm was calculated. The results are shown in Table 4.

TABLE 4

| | | | | | | | | | Landing rate |
|---|---|---|---|---|---|---|---|---|---|
| | | | | | Surface | | | | on exposed |
| | | Name of | | | tension | Viscosity | | | area (at 0.25 |
| | Liquid oily | pharmaceutical | | | (at 25° C.) | (at 23° C.) | | | mg/cm²) |
| | component | component | Manufacturer | Trade name | [mN/m] | [mPa · s] | Rotor | (rpm) | [%] |
| Example 29 | Silicone oil a1 | Dimethylpolysiloxane | Shin-Etsu Chemical | Silicone KF- | 19 | 5 | L Adaptor | 30 | 5 |
| | | | Co., Ltd. | 96A-6cs | | | | | |
| Example 30 | Silicone oil a3 | Dimethylpolysiloxane | Shin-Etsu Chemical | Silicone KF- | 21 | 210 | M2 | 12 | 28 |
| | | | Co., Ltd. | 96-200cs | | | | | |
| Example 31 | Ester oil b5 | Isopropyl myristate | Kao Corporation | Exceparl | 28 | 5 | L Adaptor | 30 | 24 |
| Example 32 | Ether oil c1 | Cetyl-1, | | IPM | 28 | 7 | L Adaptor | 30 | 15 |
| | | 3-dimethylbutyl | | | | | | | |
| | | ether | | | | | | | |
| Example 33 | Hydrocarbon | Squalene | Nippon Surfactant | Nikkol | 30 | 42 | M2 | 12 | 12 |
| | oil d3 | | Industries Co., Ltd. | Squalane | | | | | |
| Comparative | Silicone oil ax2 | Dimethylpolysiloxane | Shin-Etsu Chemical | Silicone KF- | 21 | 4500 | M2 | 6 | 73 |
| Example 3 | | | Co., Ltd. | 96-5000cs | | | | | |
| Comparative | Polyhydric | Glycerin | Kao Corporation | Purified | 65 | 950 | M2 | 12 | 75 |
| Example 4 | alcohol fx2 | | | Glycerin | | | | | |

From Table 4, even in the test for confirming the repellent effect on the human forearm, the same results as those in the test for confirming the repellent effect on the replica skin substrate were obtained. That is, in the repellents of Comparative Examples 3 and 4, the mosquito landing rate is 73% or more, and the repellent effect is insufficient, whereas in the repellents of Examples 29 to 33, the mosquito landing rate is low as 28% or less, so that it is noted that the excellent repellent effect is exhibited.

### INDUSTRIAL APPLICABILITY

The pest repellent of the present invention is excellent in repellent effect against pests, particularly flying pests, and is safe and odorless. Accordingly, the pest repellent of the present invention can be used for not only infants and people with sensitive skin, but also consumers who dislike application of chemicals with confidence.

What is claimed is:

1.-14. (canceled)

15. A method for repelling pests, comprising applying a pest repellent onto a skin surface of a human such that an amount of a liquid oily component is 0.1 mg or more per 1 cm², wherein the pest repellent comprises, as an active ingredient, at least one liquid oily component selected from the group consisting of a silicone oil, an ester oil, an ether oil, a hydrocarbon oil, an aliphatic higher alcohol having 14 or more carbon atoms, and a polyhydric alcohol, the liquid oily component having a surface tension at 25° C. of 40 mN/m or less and a viscosity at 23° C. as measured with a B-type rotational viscometer of 1,200 mPa·s or less.

16. The method for repelling pests according to claim 15, wherein the liquid oily component has a surface tension at 25° C. of 15 mN/m or more and 30 mN/m or less and a viscosity at 23° C. as measured with a B-type rotational viscometer of 5 mPa·s or more and 580 mPa·s or less.

17. The method for repelling pests according to claim 15, wherein the liquid oily component is a silicone oil, and the content of the silicone oil in the pest repellent is 20% by mass or more and 80% by mass or less.

18. The method for repelling pests according to claim 15, wherein the pest is a flying pest.

19. The method for repelling pests according to claim 15, wherein the pest repellent is attached onto a limb of the pest, thereby preventing the pest from staying on a human skin.

20. The method for repelling pests according to claim 15, comprising applying the pest repellent onto the skin surface of a human such that the amount of the liquid oily component is 3 mg or less per 1 cm².

21. A method for repelling pests, comprising applying a pest repellent composition onto a skin surface of a human such that an amount of a liquid oily component is 0.1 mg or more per 1 cm², wherein the pest repellent composition comprises at least one liquid oily component selected from the group consisting of a silicone oil, an ester oil, an ether oil, a hydrocarbon oil, an aliphatic higher alcohol having 14 or more carbon atoms, and a polyhydric alcohol, the liquid oily component having a surface tension at 25° C. of 40 mN/m or less and a viscosity at 23° C. as measured with a B-type rotational viscometer of 1,200 mPa·s or less, and not containing an effective amount of other pest repellent.

22. The method for repelling pests according to claim 21, wherein the liquid oily component has a surface tension at 25° C. of 15 mN/m or more and 30 mN/m or less and a viscosity at 23° C. as measured with a B-type rotational viscometer of 5 mPa·s or more and 580 mPa·s or less.

23. The method for repelling pests according to claim 21, wherein the liquid oily component is a silicone oil, and the content of the silicone oil in the pest repellent is 20% by mass or more and 80% by mass or less.

24. The method for repelling pests according to claim 21, wherein the other pest repellent is at least one selected from the group consisting of DEET, Icaridin, dimethyl phthalate, 2-ethyl-1,3-hexanediol, and citronellol.

25. The method for repelling pests according to claim 21, wherein the content of the other pest repellent in the pest repellent is 3% by mass or less.

26. The method for repelling pests according to claim 21, wherein the pest is a flying pest.

27. The method for repelling pests according to claim 21, wherein the pest repellent composition is attached onto a limb of the pest, thereby preventing the pest from staying on a human skin.

28. The method for repelling pests according to claim 21, comprising applying the pest repellent composition onto the skin surface of a human such that the amount of the liquid oily component is 3 mg or less per 1 cm².
